(19) United States
(12) Patent Application Publication
(10) Pub. No.: US 2025/0193482 A1
(43) Pub. Date: Jun. 12, 2025

(54) CROSS-PLATFORM VIDEO OVERLAY ADVERTISEMENT INTERPRETER

(71) Applicant: SYNCED APPS TECHNOLOGIES LTD, RAMAT GAN (IL)

(72) Inventor: ITAI ARBEL, TEL AVIV (IL)

(21) Appl. No.: 18/967,694

(22) Filed: Dec. 4, 2024

Related U.S. Application Data
(60) Provisional application No. 63/606,607, filed on Dec. 6, 2023.

(51) Int. Cl. H04N 21/431; H04N 21/45; H04N 21/81

(52) U.S. Cl. CPC H04N 21/4316; H04N 21/4532; H04N 21/812

(57) ABSTRACT

A computer-implemented method for real-time creative creation includes retrieving a creative definition object (CDO) that contains a set of instructions related to one or more creative assets, each associated with a set of layout and behavior instructions, retrieving the assets, rendering the assets according to the set of instructions and displaying the output. A computer-implemented system for real-time creative creation includes at least one memory and one processor communicatively coupled to the memory and a rendering module activated by a streaming application equipped with a video player. The rendering module is configured to retrieve a CDO that contains instructions related to one or more creative assets, each creative asset associated with a set of layout and behavior instructions, retrieve the creative assets, render them according to the set of instructions and display the rendered creative on a display.

### FIELD

The invention relates generally to the field of overlaying content on digital video streams and an in particular to a cross platform creative compiler.

### BACKGROUND

In advertising and media, content created to communicate a specific message to an audience is commonly referred to as a “creative.” A creative typically consists of various components, known as creative assets, which include media elements and design features that collectively form an advertisement.

Overlays on video content have gained popularity as a means to enhance viewer engagement and enable both interactive and non-interactive advertisements. Ads can be integrated into video streams using two primary methods: server-side ad insertion (SSAI) and client-side ad insertion (CSAI).

SSAI involves stitching ads directly into the video stream on the server, ensuring seamless playback as the ads appear as an integral part of the video. In contrast, CSAI dynamically requests and inserts ads during video playback on the client device, enabling greater personalization and interactivity.

CSAI methods support dynamic screen layouts that accommodate both primary video content and creative assets, such as advertisements or interactive overlays. This is achieved through predefined templates in the client application, allowing content such as TV shows, sports events, or live broadcasts to continue playing seamlessly while the creative is displayed without obscuring the primary content.

Advertisements integrated via CSAI can be interactive, encouraging viewer engagement through actions like clicking, exploring features, or responding to prompts (e.g., surveys or product showcases). This approach enhances user interaction while offering flexibility to deliver ad formats tailored to individual viewers' preferences and device capabilities.

Server-Guided Ad Insertion (SGAI) is a hybrid approach combining the strengths of CSAI and SSAI. It allows streaming services to seamlessly insert personalized advertisements into video streams while maintaining a smooth viewing experience. In SGAI, the server determines when and where ad breaks can occur, however, the client-side video player performs the actual insertion and playback of ads.

Despite its advantages, existing methods often lack seamless integration and fail to provide the flexibility needed to accommodate dynamic data requirements. Additionally, many of these methods are proprietary, limiting compatibility with specific platforms or services.

### SUMMARY

There is provided in accordance with an embodiment of the invention a computer-implemented method for real-time creative creation. The method includes retrieving a creative definition object (CDO) that includes a set of instructions related to one or more creative assets, each creative asset associated with a set of layout and behavior instructions, retrieving the assets, rendering the creative assets according to the set of instructions thereby creating the creative, and displaying the creative.

Moreover, in accordance with an embodiment of the invention, the CDO further includes a second set of instruction related to a video and wherein the rendering step further includes rendering the video according to the second set of instructions.

Additionally, in accordance with an embodiment of the invention, the CDO further includes a set of general instructions related to the overall playback process. The set includes a rectangle on the screen dedicated for displaying a video, a background behind the video and the creative, animation characteristics, fonts, duration, and sound level.

Furthermore, in accordance with an embodiment of the invention, the CDO further includes a set of data instructions. The set includes endpoints, supported API for receiving personalized information, instructions for controlling a video, and API for receiving ad related data.

Still further, in accordance with an embodiment of the invention, the method also includes a step of receiving a trigger that is raised at predefined points during playback, at scheduled specific time intervals within the stream, or in response to predefined user interactions.

Moreover, in accordance with an embodiment of the invention, the trigger is raised by a third-party application.

Additionally, in accordance with an embodiment of the invention, the trigger includes instructions related to a creative asset.

Moreover, in accordance with an embodiment of the invention, the CDO is personalized.

Additionally, in accordance with an embodiment of the invention, the CDO is per channel.

There is provided in accordance with an embodiment of the invention a computer-implemented system for real-time creative creation. The system includes at least one memory, at least one processor communicatively coupled to the memory, and a rendering module activated by a streaming application equipped with a video player. The rendering module is configured to retrieve a creative definition object (CDO) that includes a set of instructions related to one or more creative assets, each creative asset associated with a set of layout and behavior instructions, retrieve the creative assets, render the creative assets according to the set of instructions thereby creating the creative, and display the creative.

Furthermore, in accordance with an embodiment of the invention, the rendering module is further configured to receive a trigger to display a creative while streaming a video by the video player and wherein the trigger is raised at predefined points during playback, at scheduled specific time intervals within the stream, or in response to predefined user interactions.

### BRIEF DESCRIPTION OF THE DRAWINGS

The invention will now be described in relation to certain examples and embodiments thereof with reference to the following illustrative drawing figures so that it may be more fully understood. In the drawings:

FIG. 1 is a schematic illustration of cross platform creative interpreter for SGAI constructed and operative in accordance with an embodiment of the invention;

FIG. 2 is a schematic illustration of the structure of a creative definition object and the type of instructions supported by its schema accordance with an embodiment of the invention;

FIG. 3 is a schematic illustration of a rendering module rendering component, constructed and operative in accordance with an embodiment of the invention; and

FIG. 4 is a schematic illustration of a flow implemented by the rendering module according to an embodiment of the invention.

It will be appreciated that for simplicity and clarity of illustration, elements shown in the drawing figures have not necessarily been drawn to scale. For example, the dimensions of some of the elements may be exaggerated relative to other elements for clarity. Further, where considered appropriate, reference numerals may be repeated among the drawing figures to indicate the same or analogous elements.

### DETAILED DESCRIPTION

In the following description, various aspects of the invention will be described. For purposes of explanation, specific configurations and details are set forth in order to provide a thorough understanding of the invention. However, it will also be apparent to one skilled in the art that the invention may be practiced without the specific details presented herein. Furthermore, well known features may be omitted or simplified in order not to obscure the invention.

Embodiments of the invention provide systems and methods offering seamless insertion of personalized advertisements into video streams while maintaining a smooth viewing experience. Embodiments of the invention provide a real-time, cross platform creative interpreter (CPCI) for SGAI, that functions as a plugin integrated into a client video player where the server determines when to insert a creative and specifies the elements that should compose it, and the client is responsible for rendering the creative and displaying it on the screen.

The CPCI includes real-time definition, adaptation and presentation of content and layout. The CPCI includes obtaining platform agnostic instructions to display ads alongside the video, and a content rendering module that implements the instruction and renders a combined visual output of the video and ads tailored to the platform it operates on. The content may be interactive.

The platform includes a scheme designed for defining, requesting, and displaying ads based on a defined layout that accommodates both the video content and the ads. It specifies the creative assets (e.g., ads), their placement and behavior during playback, and the layout adaptation required for seamless arrangement of the video content and the ads. First, the platform dynamically obtains information describing the creative content and its layout (the scheme) and then the platform obtains the creative assets and delivers the video and the creative content using a predefined layout that determines the arrangement of the creative elements alongside the video.

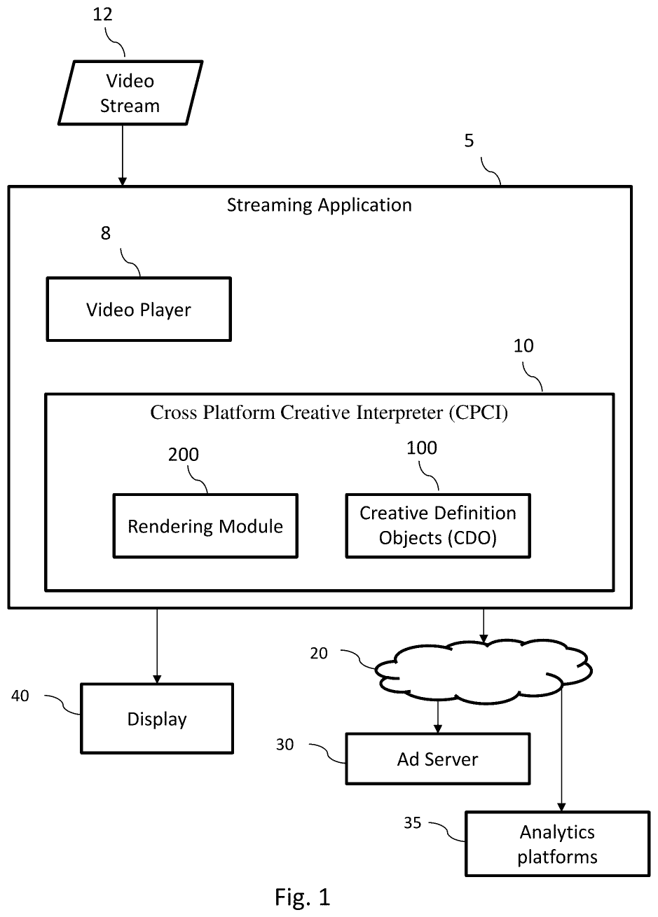

FIG. 1, to which reference is now made, is a schematic illustration of CPCI 10 constructed and operative in accordance with an embodiment of the invention. CPCI 10 may function as a plugin or add-on for a streaming application 5 that operates a video player 8 to handle video stream 12. CPCI 10 may communicate with one or more ad servers 30 via cloud 20 to retrieve advertisements and related information as well as interact with various analytics platforms 35. CPCI 10 may render creative content and display it alongside the video on display 40. CPCI 10 comprises a creative definition object (CDO) 100 and a rendering module 200.

Ads server 30 may be any server offering ad services. Ads server 30 may be Google Ad Manager (GAM), Kevel, OpenX, Magnite and the like, supporting any standard video ad serving template like VAST, VMAP, VPAID, DAAST and the like.

CDO 100 may provide information, in a predefined structure (i.e., a schema), related to the creative assets, layout and view comprising the final creative. CDO 100 offers a framework for defining creative elements and supports a wide range of creative assets. The supported assets include images, videos, QR codes, labels, text boxes, buttons and more, each associated with design attributes such as position, size, opacity, animation, and behavior settings, including the action to be taken upon interaction.

CDO 100 may facilitate dynamic data integration by establishing links between third-party data files stored in ads servers 30 and specific elements within schema elements. This enables real-time updates and interactions based on external data, which may be either static or dynamic.

The layout defined by the schema of CDO 100 may be any possible layout including Lower Third, L-band, Transparent overlay, Picture-in-Picture (PIP), Sidebar Ads, Split-Screen Ads, and the like. A creative element may be any type of object (e.g., buttons, images, videos and the like) and the associated information may include parameters relevant to its display such as position, size, opacity, animation, behavior settings (e.g., the sequence of actions following each interaction with the element) and more. The view may contain details regarding the display properties, including elements like colors, fonts, and similar attributes.

The creative content defined by CDO 100 may include polls and advertisements, which can take various forms and structures. These encompass a wide range of formats, such as banners, overlays, video interstitials, interactive elements, and others.

CDO 100 may provide custom analytics tracking based on viewer interaction with the presented elements. Each object may have associated analytics endpoints that may be triggered upon specific events, providing real-time data capture for engagement analytics.

CDO 100 may be implemented as a file or protocol designed to convey information to CPCI. It may be realized as a dedicated file written in formats like XML, JSON or similar languages. Additionally, it can be used in conjunction with standardized frameworks, like the Video Ad Serving Template (VAST) which offers a structured protocol for delivery, management and tracking of video advertisements across various platforms and devices.

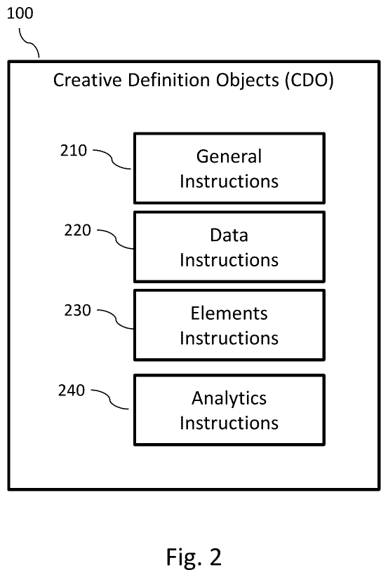

FIG. 2, to which reference is now made, is a schematic illustration of the type of instructions supported by the schema of CDO 100 according to an embodiment of the invention. CDO 100 comprises general instructions 210; data instructions 220; elements instructions 230 and analytics instructions 240.

General instructions 210 may provide general information intended for use by rendering module 200 to accurately render the creative. This information primarily pertains to the overall playback process rather than specific items within the playback. General instructions 210 may include the video rectangle in the screen (the area on the screen designated for displaying the video), the background behind the video and the creative content; animation characteristics; type of supported fonts and link to them, internal points (predefined moments or cues within the video's timeline where ads can be inserted), duration, sound level, hints for displaying on different platforms, reference to analytics tools, and the like.

Data instructions 220 may contain endpoints (network addresses or interfaces that facilitate communication between the client application and ad-related services), supported API for receiving personalized information, instructions for controlling the video (start, stop, reduce the sound, increase the sound, resize the video to a certain size and the like), API for receiving ad related data, response to presented questions, focus management, client past behavior, and the like.

Elements instructions 230 may contain various creative assets, including visual, audio, interactive, text, and metadata or technical description. Visual elements may encompass video clips, static images, animations, graphics such as logos or branding elements, and overlays or banners. Audio elements can include background music, voiceovers, and sound effects. Interactive elements may feature clickable buttons like “Learn More” or “Buy Now,” call-to-action (CTA) description, and interactive features such as quizzes or polls. Text elements might consist of ad copy, including headlines, descriptions, CTAs, product or service descriptions, and legal disclaimers. Additionally, creative assets may include metadata and technical files, such as ad tags to ensure compatibility with ad servers, tracking pixels for analytics, and file formats compliant with industry standards like MP4 for video or VAST-compliant XML files.

The types of objects described in elements instructions 230 as part of the creative assets may include videos, labels, input fields, images, QR codes, buttons and the like. Each object in elements instructions 130 may include rendering instructions and parameters. The instructions related to each object may cover design, text, sound, animation, analytics, behavior and other instructions. The design instructions may further include type (e.g., button, text), value, location relative to its parent, alignment, size, font, font color, font size, font weight and the like.

Analytics instructions 240 may provide for each object a set of associated analytics endpoints and their activation and optionally an indication of a specific analytic platform 35. The activation of an analytic endpoint may be triggered by specified events, each potentially activating a dedicated analytics procedure.

Rendering module 200 is a component operated by a streaming application (Connected TV (CTV), smart TV, streaming devices, mobile, Web etc.) that may function as a plugin or an add-on implementing the instructions provided by CDO 100. Rendering module 200 is designed to manage data acquisition flow, internal and external communications, data mapping and interpretation logic related to creatives, and to control the rendering output and subsequent UI elements within a video stream including focus management of the interactive elements.

The client may be configured with ad breaks (points where ads should be added to the video stream). The ad break can be inserted at predefined time intervals during streaming or dynamically triggered by specific events, user interactions, or third-party applications. When reaching an ad break rendering module 200 may first get a relevant CDO 100, process it, and subsequently retrieve the relevant items and render the layout according to the definition in CDO 100.

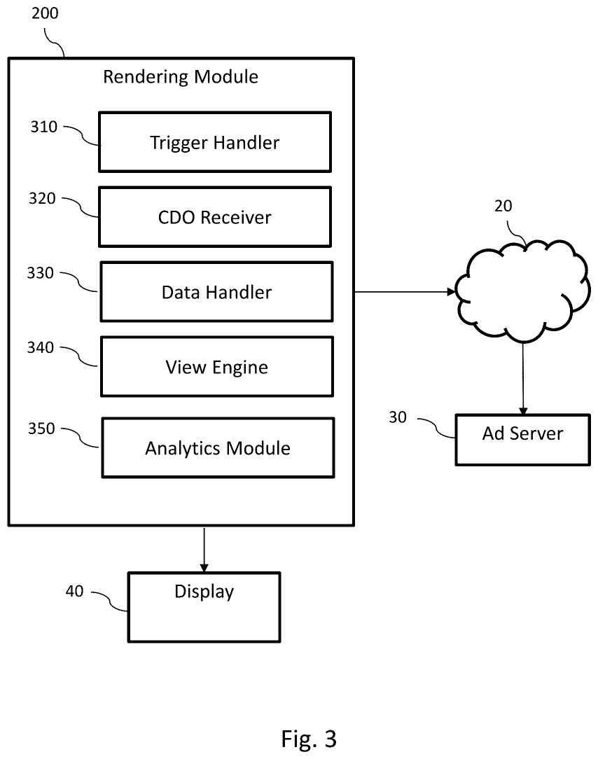

FIG. 3, to which reference is now made, is a schematic illustration of rendering module 200, constructed and implemented in accordance with an embodiment of the invention. Rendering module 200 comprises a trigger handler 310, a CDO retriever 320, a data handler 330, a view engine 340, and an analytics module 350.

Trigger handler 310 may receive a trigger to start rendering the creative defined in CDO 100. Trigger handler 310 may communicate with internal and external sources and may handle various triggers. Trigger handler 310 may handle triggers raised at predefined points during playback, e.g., pre-roll, mid-roll, or post-roll or scheduled at specific time intervals within the stream. Trigger handler 310 may also handle triggers generated by events, user interactions, or third-party applications (e.g., AWS Shoppable) that identify optimal moments for ad insertion. When received from a third-party application, the trigger may include information, including identification of creative assets, in addition or instead those defined in CDO 100.

Trigger handler 310 may communicate with sources such as JSON, XML or any other static files, HLS Manifests, socket-based communications and the like.

CDO retriever 320 may retrieve an instance of CDO 100 associated with the specific trigger from any specified location, including from ad servers 30. A different CDO 100 may be retrieved at different points in time, for different channels and for different users of the application. CDO 100 may be personalized and may contain information, especially in data instructions 220, relevant for the specific user, for example his age, gender, previous behavior with respect to ads and the like.

Data handler 330 may retrieve the items specified in elements instructions 230 (FIG. 2) from ads server 30. Data handler 330 may use APIs defined in CDO 100 to access the relevant servers, also defined in CDO 100, and may retrieve the needed information associated with the creative assets including images, video files and any other object.

View engine 340 may utilize the definitions in CDO 100 to render a layout that incorporates the relevant elements, including any UI components that implement the desired functionality (e.g., shrinking effects). It may be noted that view engine 340 may render the creative assets on a part of the screen while shrinking the video or may render a view containing only the creative assets for example while the video is paused. View engine 340 may display the rendered creative on display 40.

View engine 340 may support dynamic changes in the size and position of the video player while it is actively streaming content enabling for example a seamless transition to an “L-band” layout, where the main video content is shrunk and repositioned to make space for additional creative assets such as advertisements or interactive panels by restructuring the viewing area to incorporate secondary information harmoniously.

View engine 340 may utilize the information in CDO 100 which defines attributes related to the video player. Rendering module 200 may receive a trigger to adjust the view in response to certain events or viewer interactions. For example, when a viewer selects an option to learn more about a product featured in the video, view engine 340 may resize and reposition the video stream to a corner of the screen, while simultaneously displaying detailed product information or even offering interactive purchase options alongside.

Analytics module 350 may call the relevant analytics API upon receiving a trigger to collect and send information related to the view and/or the user interaction. The analytics server and details may be defined in CDO 100.

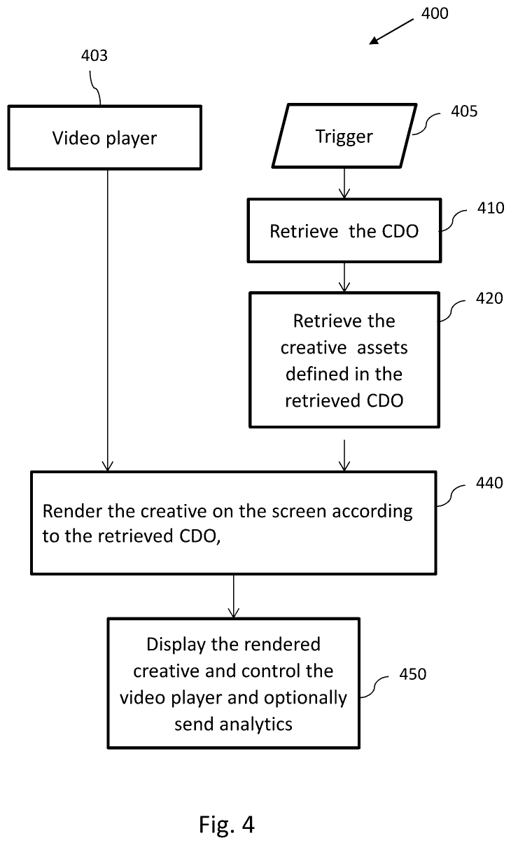

FIG. 4, to which reference is now made, is a schematic illustration of a flow 400 implemented by rendering module 200 according to an embodiment of the invention.

Rendering module 200 may receive a video player 403 and a trigger 405 indicating that an ad break has been reached. In step 410 CDO receiver 320 may retrieve a specific CDO 100 and in step 420 data handler 330 may retrieve the creative assets as defined in the retrieved CDO 100 along with any additional creative assets specified by trigger 405 if applicable. In step 440 view engine 340 may render the creative according to the layout defined in the retrieved CDO 100. In step 450 rendering module 200 may display the rendered creative on display 40 while controlling the video player and send any relevant analytics.

Embodiments of the invention provide a client-side interactive and dynamic system and method capable of manipulating a video stream according to definitions specified in a dynamic creative definition object instructing how to add elements (e.g., ads) to a video in video streaming applications. Additionally, embodiments of the invention provide a system and method for dynamically defining a potentially personalized layout and personalized creative assets to add during video streaming, as well as for rendering the combined visuals

It may be appreciated that the steps shown for the flows herein above are not intended to be limiting and that each flow may be practiced with variations. These variations may include more steps, less steps, changing the sequence of steps, skipping steps, among other variations which may be evident to one skilled in the art.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Unless specifically stated otherwise, as apparent from the following discussions, it is appreciated that throughout the specification discussions utilizing terms such as “analyzing”, “processing,” “computing,” “calculating,” “determining,” “detecting”, “identifying” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

What is claimed is:

1. A computer-implemented method for real-time creative creation, the method comprising:
retrieving a creative definition object (CDO), wherein the CDO comprises a set of instructions related to one or more creative assets, each creative asset associated with a set of layout and behavior instructions;
retrieving the assets;
rendering the creative assets according to the set of instructions thereby creating the creative; and
displaying the creative.

2. The method of claim 1 wherein the CDO further comprises a second set of instruction related to a video and wherein the rendering step further comprises rendering the video according to the second set of instructions.

3. The method of claim 1 wherein the CDO further comprises a set of general instructions related to the overall playback process, the set including any of a rectangle on the screen dedicated for displaying a video, a background behind the video and the creative, animation characteristics, fonts, duration, and sound level.

4. The method of claim 1 wherein the CDO further comprises a set of data instructions, the set including any of endpoints, supported API for receiving personalized information, instructions for controlling a video, and API for receiving ad related data.

5. The method of claim 1 also comprising a step of receiving a trigger wherein the trigger is raised at one or more of predefined points during playback, scheduled specific time intervals within the stream, and the occurrence of predefined user interactions.

6. The method of claim 5 wherein the trigger is raised by a third-party application.

7. The method of claim 6 wherein the trigger includes instructions related to a creative asset.

8. The method of claim 1 wherein the CDO is personalized.

9. The method of claim 1 wherein the CDO is per channel.

10. A computer-implemented system for real-time creative creation, the system comprising:
at least one memory;
at least one processor communicatively coupled to the memory;
a display; and
a rendering module activated by a streaming application equipped with a video player, the rendering module is configured to
retrieve a creative definition object (CDO), wherein the CDO comprises a set of instructions related to one or more creative assets, each creative asset associated with a set of layout and behavior instructions,
retrieve the creative assets,
render the creative assets according to the set of instructions thereby creating the creative, and
display the creative on the display.

11. The system of claim 10 wherein the CDO further comprises a second set of instruction related to a video and wherein the rendering module is further configured to render the video according to the second set of instructions.

12. The system of claim 10 wherein the CDO further comprises a set of general instructions related to the overall playback process, the set including one or more of a rectangle on the screen dedicated for displaying a video, a background behind the video and the creative, animation characteristics, fonts, duration, and sound level.

13. The system of claim 10 wherein the CDO further comprises a set of data instructions, the set including any of endpoints, supported API for receiving personalized information, instructions for controlling a video, and API for receiving ad related data.

14. The system of claim 10 wherein the rendering module is further configured to receive a trigger to display a creative while streaming a video by the video player and wherein the trigger is raised at one or more of predefined points during playback, scheduled specific time intervals within the stream, and the occurrence of predefined user interactions.

15. The system of claim 14 wherein the trigger is raised by a third-party application.

16. The system of claim 15 wherein the trigger includes instructions related to a creative asset.

17. The system of claim 10 wherein the CDO is personalized.

18. The system of claim 10 wherein the CDO is per channel.
